(19) United States
(12) Patent Application Publication
(10) Pub. No.: US 2014/0150085 A1
(43) Pub. Date: May 29, 2014

(54) USER AUTHENTICATION BASED ON A USER'S OPERATION ON A DISPLAYED THREE-DIMENSIONAL MODEL

(71) Applicant: INTERNATIONAL BUSINESS MACHINES CORPORATION, Armonk, NY (US)

(72) Inventors: SANEHIRO FURUICHI, TOKYO (JP); TAKAHITO TASHIRO, TOKYO (JP)

(73) Assignee: INTERNATIONAL BUSINESS MACHINES CORPORATION, Armonk, NY (US)

(21) Appl. No.: 14/061,151

(22) Filed: Oct. 23, 2013

(30) Foreign Application Priority Data
Nov. 28, 2012 (JP) 2012-260254

(51) Int. Cl. G06F 21/36

(52) U.S. Cl. CPC G06F 21/36
USPC 726/17

(57) ABSTRACT

An authentication device authenticates a user based on a user's operation. The authentication device comprises a display control unit, an operation input unit, and an authentication unit. The display control unit is a processor-based logic that displays a three-dimensional model on a display device. The operation input unit is a hardware unit that inputs a user's operation on the displayed three-dimensional model. The authentication unit is a processor-based logic that authenticates the user based on the user's operation, wherein the user's operation comprises a change operation of at least one of a position and posture of the three-dimensional model having been input from the user.

This application is based on and claims the benefit of priority from Japan (JP) Patent Application No. 2012-260254, filed on Nov. 28, 2012, and herein incorporated by reference in its entirety.

### BACKGROUND

The present invention relates to an authentication device, an authentication program, and an authentication method.

One known method of authenticating a user is to make the user input a character string such as a password. In addition, there are known methods of decoding an authentication unlock pattern from an oil spot left on the screen of a smartphone or similar devices. Another process for authenticating a user is to authenticate the user by detecting a user's line of sight to an object in a box.

According to an authentication method using a password, however, a user needs to remember the character string of a password correctly. Moreover, if the user is made to input the same authentication operation into a device, an authentication unlock pattern might be decoded by a third party.

According to the method described in which the user is authenticated by detecting a user's line of sight to an object in a box, it is difficult to authenticate the user unless the device is able to detect a user's viewpoint correctly. Moreover, in this method the user needs to prepare a real box, which leads to inconvenience when the user carries the device.

### SUMMARY

In one embodiment of the present invention, an authentication device authenticates a user based on a user's operation. The authentication device comprises a display control unit, an operation input unit, and an authentication unit. The display control unit is a processor-based logic that displays a three-dimensional model on a display device. The operation input unit is a hardware unit that inputs a user's operation on the displayed three-dimensional model. The authentication unit is a processor-based logic that authenticates the user based on the user's operation, wherein the user's operation comprises a change operation of at least one of a position and posture of the three-dimensional model having been input from the user.

In one embodiment of the present invention, a method and/or computer program product authenticates a user based on a user's operation. The method comprises: displaying a three-dimensional model on a display device; receiving, by one or more processors, an input of a user's operation on the displayed three-dimensional model; and authenticating, by one or more processors, the user based on an operation, wherein the operation comprises a change operation of at least one of the position and posture of the three-dimensional model having been input from the user.

The foregoing summary of the invention is not a list of features required for the present invention. In addition, any subcombination of these features could also constitute the invention.

### BRIEF DESCRIPTION OF THE SEVERAL VIEWS OF THE DRAWINGS

FIG. 1 is a diagram illustrating the configuration of an authentication system 1 of this embodiment;

FIG. 2 is a flowchart of the authentication registration of the authentication system 1 of this embodiment;

FIG. 3 is a flowchart of the authentication processing of the authentication system 1 of this embodiment;

FIG. 4 is a flowchart of the authentication processing of the authentication system 1 of a modification of this embodiment;

FIG. 5 is a diagram illustrating an example of a three-dimensional model used in this embodiment;

FIG. 6 is an enlarged view of a part (bird's head) of the three-dimensional model illustrated in FIG. 5;

FIG. 7 is an enlarged view of a part (bird's back) of the three-dimensional model illustrated in FIG. 5;

FIG. 8 is an enlarged view of a part (bird's rear side) of the three-dimensional model illustrated in FIG. 5; and

FIG. 9 is a diagram illustrating an example of a hardware configuration of a computer 1900.

### DETAILED DESCRIPTION

Hereinafter, the present invention will be described in illustrative embodiments. It should be noted, however, that the following embodiments are not intended to limit the scope of the appended claims, and that not all the combinations of features described in the embodiments are necessarily essential to the solving means of the present invention.

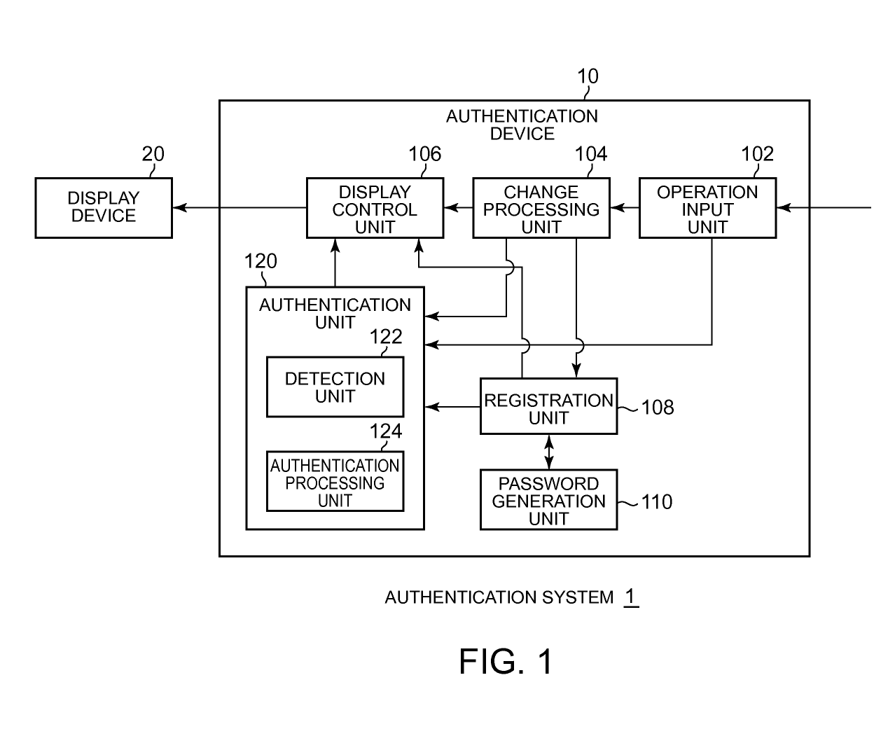

FIG. 1 illustrates the configuration of an authentication system 1 of this embodiment. The authentication system 1 authenticates a user by making a user operate a three-dimensional model. The authentication system 1 includes an authentication device 10 which performs authentication processing and a display device 20 which displays the three-dimensional model for authentication on a screen.

The authentication device 10 is a computer which authenticates a user on the basis of a user's operation such as, for example, a personal computer, a cell phone, or a mobile terminal. The authentication device 10 has an operation input unit 102, a change processing unit 104, a display control unit 106, a registration unit 108, a password generation unit 110, and an authentication unit 120.

The operation input unit 102 has, for example, a mouse, a touch panel, and/or a keyboard and inputs a user's operation for a three-dimensional model displayed on the display device 20. For example, the operation input unit 102 inputs a click operation and a drag-and-drop operation with a mouse. For example, the operation input unit 102 inputs a tapping operation and a sliding operation with one finger or with two or more fingers on a touch panel. For example, the operation input unit 102 inputs an operation of pressing a button on a mouse and/or a keyboard. Moreover, the operation input unit 102 receives a request for authentication and a request for registration of an authentication operation from a user.

The operation input unit 102 receives at least one of the position and posture of the three-dimensional model from the user. Moreover, the operation input unit 102 receives a specification operation of specifying at least one of a point and a region on the three-dimensional model from the user when the user is authenticated and when the authentication operation for use in the authentication is registered. The region may include a line and a surface. The operation input unit 102 may input the specification operation with respect to a plurality of places on the three-dimensional model.

The operation input unit 102 supplies information on the change operation and information on the specification operation to the change processing unit 104. The operation input unit 102 supplies the request for authentication and the request for the registration of an authentication operation issued by the user to the authentication unit 120.

The change processing unit 104 changes at least one of the position and posture of the three-dimensional model on the display screen in response to an input of the change operation from the user via the operation input unit 102. The change processing unit 104 is able to change the position, size, and/or direction of the three-dimensional model on the display screen by changing the position and/or posture of the three-dimensional model. The change processing unit 104 supplies information including the position and posture of the three-dimensional model to the display control unit 106.

Moreover, upon the input of the specification operation for the three-dimensional model, the change processing unit 104 projects the point and/or region on the screen specified in the specification operation onto the three-dimensional model and identifies the coordinates of the point and/or region projected on the three-dimensional model. The change processing unit 104 supplies the identified coordinates to the display control unit 106. Further, the change processing unit 104 supplies the identified coordinates to the registration unit 108 in the registration of the authentication operation and to the authentication unit 120 in the authentication.

The display control unit 106 performs display control for displaying the three-dimensional model on the display device 20. For example, the display control unit 106 receives information including the position and posture of the three-dimensional model from the change processing unit 104 before and after the change operation performed by the user and generates image information on the three-dimensional model appropriate to the position and posture of the three-dimensional model.

Moreover, the display control unit 106 acquires the coordinates projected on the three-dimensional model by the specification operation from the change processing unit 104 and generates image information in which the point and/or region related to the specification operation is projected on the three-dimensional model. Thereby, the user is able to confirm the point and/or region specified on the three-dimensional model by the specification operation. The display control unit 106 supplies the generated image information to the display device 20 to cause the display device 20 to display an image.

The registration unit 108 includes a nonvolatile memory such as an EPROM, a flash memory, or a hard disk and registers at least one of the point and region on the three-dimensional model specified by the user during registration process of the specification operation as at least one of the point and region for authentication. For example, the registration unit 108 receives the coordinates of the point and/or region related to the specification operation projected on the three-dimensional model from the change processing unit 104 and stores the coordinates as information on the specification operation for authentication.

Moreover, in a case where a plurality of specification operations is registered for one three-dimensional model during registration process, the registration unit 108 determines whether at least one of the point and region for each of the plurality of places on the three-dimensional model specified by the user is able to be specified in the same position and posture of the three-dimensional model. If the point or region for each is able to be specified in the same position and posture, the registration unit 108 may warn the user of low authentication strength.

Upon the completion of all registration processes of the specification operation for the three-dimensional model, the registration unit 108 supplies end information to the password generation unit 110 and stores a password for authentication. Receiving the request from the authentication unit 120, the registration unit 108 supplies information such as the point or the like on the three-dimensional model registered in the authentication unit 120 to the authentication unit 120.

The password generation unit 110 generates the password for authentication. For example, the password generation unit 110 may generate the password for authentication in response to an operation for authentication for the three-dimensional model. The password generation unit 110 causes the password for authentication to be stored in the registration unit 108. The password generation unit 110 may supply the information on the generated password for authentication to the display control unit 106 via the registration unit 108 to cause the display device 20 to present the password for authentication to the user.

The authentication unit 120 authenticates the user on the basis of the operation including the change operation of at least one of the position and posture of the three-dimensional model having been input by the user. The authentication unit 120 includes a detection unit 122 and an authentication processing unit 124.

The detection unit 122 detects similarity between at least one of the point and region on the three-dimensional model specified by the user and at least one of the preset point and region for authentication. For example, the detection unit 122 acquires the point and/or region on the three-dimensional model, which the user has input to the operation input unit 102, from the change processing unit 104 and then compares the point and/or region acquired from the change processing unit 104 with the point and/or region on the three-dimensional model acquired from the registration unit 108. Thereafter, the detection unit 122 calculates the similarity in the point and/or region on the three-dimensional model between both on the basis of the distance or the like between the points and/or regions of both.

The authentication processing unit 124 makes the authentication successful on condition that the similarity is equal to or greater than a reference value. If there is a plurality of points and/or regions on the three-dimensional model for use in the authentication of the user, the authentication processing unit 124 may decide whether to make the authentication successful on the basis of a plurality of similarities detected with respect to the plurality of places on the three-dimensional model. For example, the authentication processing unit 124 may authenticate the user on the basis of the plurality of points and/or regions registered with respect to one or a plurality of three-dimensional models.

The display device 20 receives the image information from the display control unit 106 and displays an image appropriate to the image information. The display device 20 may be a display such as, for example, a liquid crystal display device, an organic EL device, or the like. The display device 20 may be mounted in the authentication device 10 so as to be integrated in the authentication device 10.

In this manner, the authentication device 10 of this embodiment is able to authenticate a user by making the user specify a point or the like on the three-dimensional model. Thus, according to the authentication device 10, the user is only required to memorize the operation for the three-dimensional model as an image, instead of a character string, thereby reducing the load on the user in comparison with a method of memorizing a password character string correctly.

Moreover, the authentication device 10 inputs the point and/or region for authentication through changing the position and posture of the three-dimensional model, and therefore the change operation is likely to be different every time, thereby improving the security to a method of decoding the authentication operation for detecting the same specification operation.

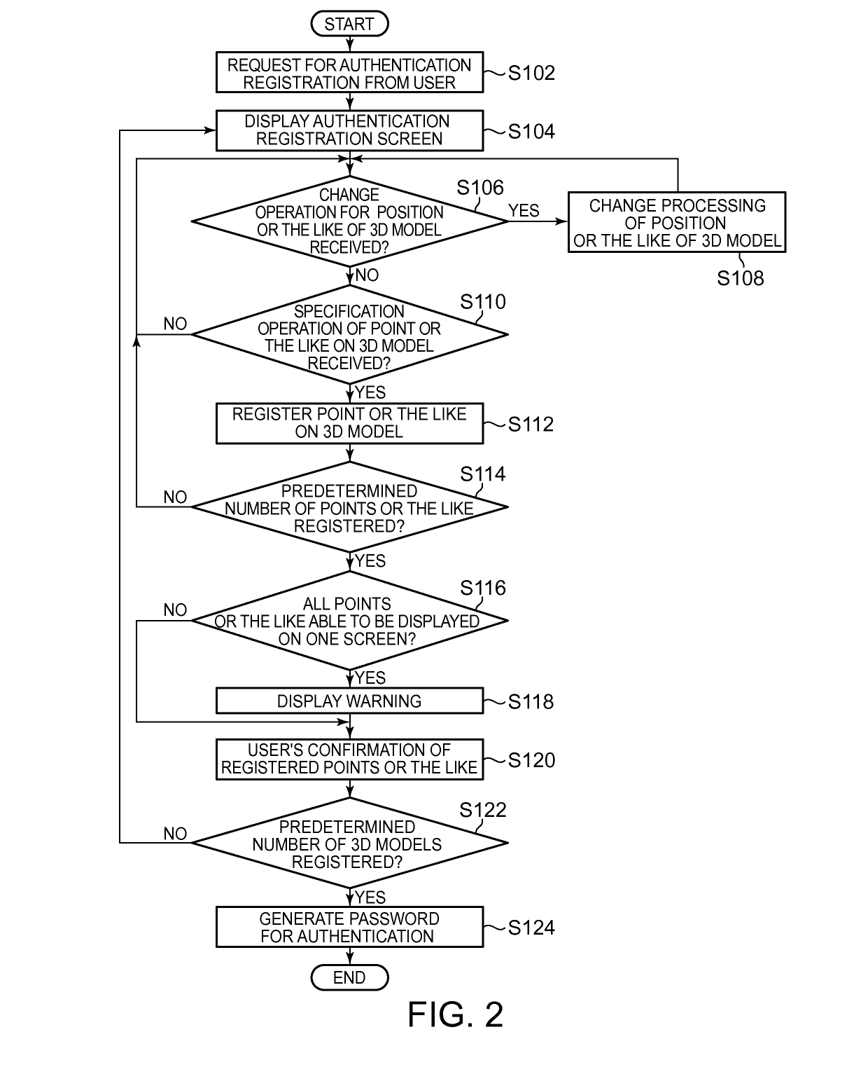

FIG. 2 illustrates a flow of the authentication registration of the authentication system 1 of this embodiment. In this embodiment, the authentication system 1 registers the point or the like for authentication by performing processing of steps S102 to S124.

First, in step S102, the operation input unit 102 receives a request for registration of the authentication operation from the user. For example, if the user selects the registration of the authentication operation on a setting screen of the authentication device being displayed on the display device 20, the operation input unit 102 inputs a request for registration. The operation input unit 102 supplies the request for registration of the authentication operation to the authentication unit 120.

Subsequently, in step S104, the authentication unit 120 supplies a request for displaying an authentication registration screen to the display control unit 106. The display control unit 106 causes the display device 20 to display the authentication registration screen for use in registering at least one of the point and region for authentication.

For example, in a case of registering a point or the like for authentication for a plurality of three-dimensional models, the change processing unit 104 selects one three-dimensional model for which any point or the like for authentication is not registered yet out of the plurality of three-dimensional models. If there is only one three-dimensional model for which any point or the like for authentication is not registered, the change processing unit 104 selects the three-dimensional model. The change processing unit 104 may use a three-dimensional model which has been stored from the beginning as a plurality of three-dimensional models or alternatively may use a three-dimensional model created by the user instead thereof.

The change processing unit 104 defines a virtual three-dimensional coordinate space for arranging the three-dimensional model and sets the initial values of the coordinates of points, lines, and surfaces constituting the selected three-dimensional model and the initial values of the coordinates and direction of a viewpoint. The change processing unit 104 supplies the initial values of positions of the selected three-dimensional model before the input of the operation from the user to the display control unit 106. For example, the change processing unit 104 supplies the initial values of the coordinates of points, lines, and surfaces constituting the three-dimensional model and the initial values of the coordinates and direction of the viewpoint to the display control unit 106.

The display control unit 106 generates image information on the selected three-dimensional model on the basis of the received initial values of the positions of the three-dimensional model and the position and the like of the viewpoint. The display control unit 106 supplies the generated image information to the display device 20 to cause the display device 20 to display the three-dimensional model.

The operation input unit 102 may input a change operation of at least one of the position and posture of the three-dimensional model and/or a specification operation of specifying at least one of the point and region on the three-dimensional model during registration process from the user for the three-dimensional model. The operation input unit 102 supplies the change processing unit 104 with information on the change operation and/or the specification operation having been input.

Subsequently, in step S106, the change processing unit 104 determines whether the change processing unit 104 has received at least one change operation of the position and posture of the three-dimensional model from the user via the operation input unit 102 during registration process. If the change processing unit 104 has received the change operation, the change processing unit 104 proceeds the processing to step S108. Unless the change processing unit 104 has received the change operation, the change processing unit 104 proceeds the processing to step S110.

In step S108, the change processing unit 104 changes at least one of the position and posture of the three-dimensional model on the display screen. For example, upon input of the change operation for changing the position of the three-dimensional model, the change processing unit 104 changes the coordinates of the points and the like constituting the three-dimensional model according to the change operation. Alternatively, the change processing unit 104 may change the coordinates and/or direction of the viewpoint according to the change operation.

For example, upon input of the change operation for bringing the three-dimensional model close to or away from the viewpoint, the change processing unit 104 may move the coordinates of the viewpoint close to or away from the coordinates of the center of the three-dimensional model. For example, upon input of the change operation for changing the posture of the three-dimensional model, the change processing unit 104 may change the posture of the three-dimensional model by rotating the coordinates of the viewpoint around the three-dimensional model. The change processing unit 104 supplies the coordinates or the like of the changed three-dimensional model and/or of the viewpoint to the display control unit 106. The change processing unit 104 proceeds the processing to step S110 upon the completion of the processing for the change operation.

In step S110, the change processing unit 104 determines whether the change processing unit 104 has received the specification operation for the three-dimensional model via the operation input unit 102. If the change processing unit 104 has received the specification operation, the change processing unit 104 proceeds the processing to step S112. Unless the change processing unit 104 has received the specification operation, the change processing unit 104 returns the processing to step S106.

In step S112, the change processing unit 104 projects the point and/or region related to the specification operation on the three-dimensional model and identifies the coordinates of the point and/or region projected on the three-dimensional model. For example, if the user inputs a graphic such as a circle on a touch panel, which is the operation input unit 102, the change processing unit 104 projects the graphic such as a two-dimensional circle input by the user onto the three-dimensional model and identifies the coordinates of the respective vertices constituting the graphic such as a circle projected on the three-dimensional model. The change processing unit 104 supplies the registration unit 108 with the identified coordinates to store the coordinates in the registration unit 108.

Moreover, the change processing unit 104 supplies the display control unit 106 with the identified coordinates. The display control unit 106 generates image information in which the coordinates are projected on the three-dimensional model. The display control unit 106 may provide a brightly-emphasized display of a point of coordinates projected on the three-dimensional model, a line formed by a plurality of coordinates, or a region enclosed by a plurality of coordinates by highlighting or the like. Thereby, the display control unit 106 is able to make the user confirm the point and/or region specified by the specification operation.

Subsequently, in step S114, the registration unit 108 determines whether the points or the like for authentication at a predetermined number of places have been registered in the selected three-dimensional model. The number of places for authentication to be registered may be one or more than one.

If a predetermined number of points or the like for authentication have been registered, the registration unit 108 proceeds the processing to step S116. Unless the predetermined number of points or the like for authentication have been registered, the registration unit 108 returns the processing to step S106 to make the user continue the registration of the points or the like for authentication for the three-dimensional model.

In step S116, if a plurality of specification operations is registered for one three-dimensional model, the registration unit 108 determines whether at least one of the point and region with respect to each of the plurality of places on the three-dimensional model specified by the user is able to be specified in the same position and posture of the three-dimensional model.

For example, the registration unit 108 determines whether the plurality of points or the like registered for authentication from the user is able to be specified with respect to the three-dimensional model at a time from one specific viewpoint. If it is determined that the specification is possible, the registration unit 108 proceeds the processing to step S118. Unless it is determined that the specification is possible, the registration unit 108 proceeds the processing to step S120.

In step S118, the registration unit 108 warns the user of low authentication strength. For example, the registration unit 108 supplies the display control unit 106 with an instruction for displaying a warning screen suggesting that the authentication strength of the points or the like for authentication is low for the three-dimensional model.

The registration unit 108 may make the user reenter the points or the like for authentication, in addition to displaying the warning screen or instead of displaying the warning screen. In this case, the registration unit 108 may erase all points or the like for authentication, which have already been registered for the selected three-dimensional model, and return the processing to step S104.

Thereby, according to the authentication device 10 of this embodiment, the authentication device 10 prevents the specification operation from being able to be input for all points or the like for authentication in the same position and posture without performing the operation of changing the posture or the like of the three-dimensional model. Therefore, the authentication device 10 is able to improve the authentication security.

In step S120, the change processing unit 104 is able to input a change operation of at least one of the position and posture of the three-dimensional model from the user via the operation input unit 102 after the input of the points or the like for authentication. The change processing unit 104 changes at least one of the position and posture of the three-dimensional model on the display screen according to the change operation and makes the user confirm the place of at least one of the point and region for authentication on the three-dimensional model. Thereby, the change processing unit 104 is able to make the user confirm whether the points or the like for authentication have been correctly specified for the three-dimensional model successfully after the registration process for one three-dimensional model.

Subsequently, in step S122, the registration unit 108 determines whether the points or the like for authentication have been registered for a predetermined number of three-dimensional models. The number of three-dimensional models to be registered may be one or more than one.

If the points or the like for authentication have been registered for the predetermined number of three-dimensional models, the registration unit 108 proceeds the processing to step S124. Unless the points or the like for authentication have been registered for the predetermined number of three-dimensional models, the registration unit 108 returns the processing to step S104 to make the user continue the registration of the points or the like for authentication for three-dimensional models for which the points or the like for authentication have not been registered yet.

In step S124, a password for authentication is generated, where the password for authentication is a password appropriate to the operation for authentication for the three-dimensional model. For example, the password generation unit 110 generates the password for authentication by stringizing the coordinates of the point or the like on the three-dimensional model specified by the specification operation and encrypting the character string with an encryption key or the like. Alternatively, the password generation unit 110 may use a character string, which has been input by the user via the operation input unit 102, as a password for authentication.

The password generation unit 110 stores the information on the generated password for authentication in the registration unit 108. Moreover, the password generation unit 110 supplies information on the generated password for authentication to the display control unit 106 via the registration unit 108, thereby causing the display device 20 to present the password for authentication to the user. The user may write the presented password for authentication on a notebook or the like and store the password in the user's home.

In this manner, the authentication system 1 according to this embodiment registers the specification operation of specifying the points or the like for the three-dimensional model by the processing of steps S102 to S124 as an operation for authentication. In addition, the authentication system 1 according to this embodiment generates an authentication password corresponding to the operation for authentication.

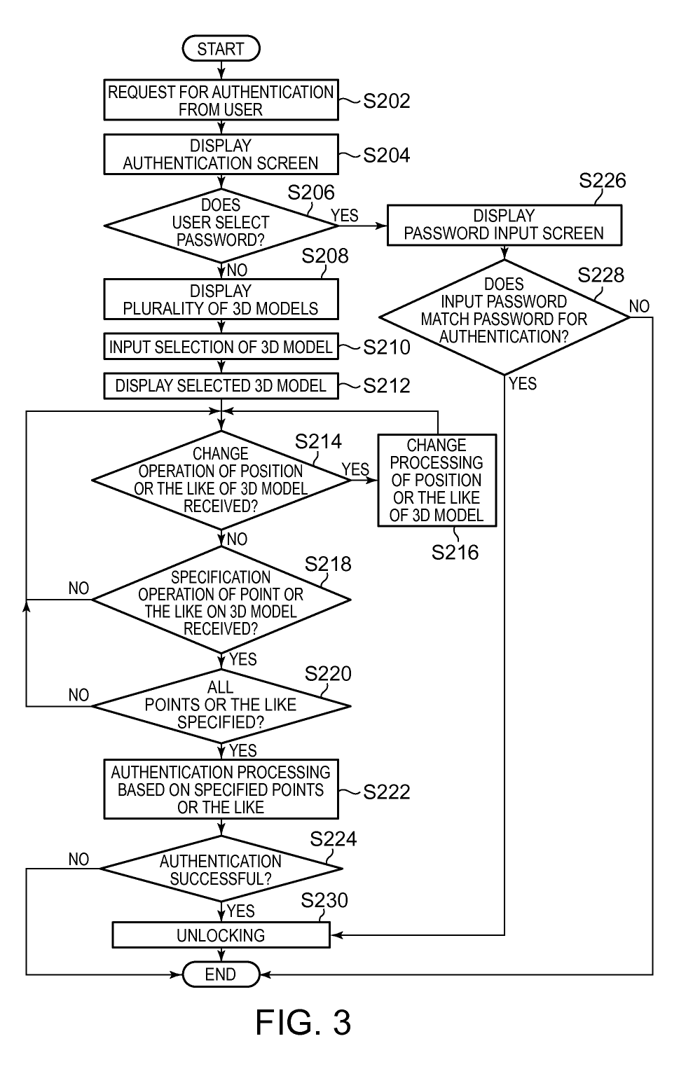

FIG. 3 illustrates a flow of the authentication processing of the authentication system 1 according to this embodiment. In this embodiment, the authentication system 1 performs the processing of steps S202 to S230 to input the operation for one three-dimensional model, thereby authenticating the user.

First, in step S202, the operation input unit 102 receives a request for authentication from the user. For example, the user performs some input operation such as touching a touch panel on an operation lock screen of the authentication device 10 displayed on the display device 20, by which the operation input unit 102 inputs the request for authentication. The operation input unit 102 supplies the request for authentication to the authentication unit 120.

Subsequently, in step S204, the authentication unit 120 supplies a request for displaying an authentication screen to the display control unit 106. The display control unit 106 causes the display device 20 to display the authentication screen. In this regard, the display control unit 106 displays a message for the user to select whether to use the three-dimensional model to perform the authentication or to use the password for authentication to perform the authentication, so that the user selects either one.

In step S206, the authentication unit 120 proceeds the processing to step S226 if having received an input of selecting the password for authentication via the operation input unit 102 or proceeds the processing to step S208 if having received an input of selecting the three-dimensional model.

In step S208, the display control unit 106 causes the display device 20 to display a plurality of three-dimensional models. In this embodiment, these three-dimensional models include only one true three-dimensional model for which the authentication operation is to be input, and other three-dimensional models are dummies. The inclusion of the dummy three-dimensional models further improves the security of the authentication device 10.

The display control unit 106 may cause the display device 20 to display images reduced in size from a plurality of three-dimensional models or icons each representing a motif of the corresponding three-dimensional model. The display control unit 106 displays a message making the user select one of the plurality of three-dimensional models, so that the user selects one three-dimensional model.

In step S210, the operation input unit 102 receives the selection of the three-dimensional model from the user. The operation input unit 102 supplies information on the selection of the three-dimensional model to the change processing unit 104 and the authentication unit 120.

Subsequently, in step S212, the display control unit 106 causes the selected three-dimensional model to be displayed. For example, the change processing unit 104 supplies the initial value of at least one of the position and posture of the selected three-dimensional model before the input of the user's operation to the display control unit 106. For example, the change processing unit 104 supplies the initial values of the coordinates of points, lines, and surfaces constituting the three-dimensional model and the initial values of the coordinates and direction of the viewpoint to the display control unit 106.

The display control unit 106 generates image information on the selected three-dimensional model on the basis of the received initial values of the position of the three-dimensional model and the position and the like of the viewpoint. The display control unit 106 supplies the generated image information to the display device 20 to cause the display device 20 to display the three-dimensional model.

The display control unit 106 may display the three-dimensional model by using different initial values of the three-dimensional model and the viewpoint in authentication processing which is performed at least more than once. Specifically, in a case of inputting points or the like for authentication more than once for the same three-dimensional model, the three-dimensional model may be displayed in different position and posture in a random manner on each initial screen. Thereby, the user performs objectively different authentication operations in the authentication processing performed more than once, and therefore the authentication device 10 is able to make it more difficult to estimate the authentication operation from a third party's observation or the like.

Subsequently, in step S214, the change processing unit 104 determines whether the change processing unit 104 has received the change operation of at least one of the position and posture of the three-dimensional model from the user via the operation input unit 102. The change processing unit 104 proceeds the processing to step S216 if having received the change operation or proceeds the processing to step S218 if not having received the change operation.

In step S216, the change processing unit 104 changes at least one of the position and posture of the three-dimensional model on the display screen. The change processing unit 104 may change the coordinates and the like of the three-dimensional model and/or the viewpoint according to the change operation, similarly to step S108 and the like.

In step S218, the authentication unit 120 determines whether the authentication unit 120 has received the specification operation for the three-dimensional model. For example, the change processing unit 104 receives the specification operation for the three-dimensional model via the operation input unit 102, projects the point and/or region related to the specification operation onto the three-dimensional model, identifies the coordinates projected on the three-dimensional model, and supplies the coordinates to the authentication unit 120. The authentication unit 120 proceeds the processing to step S220 if having received the coordinates related to the specification operation. The authentication unit 120 temporarily stores the received coordinates. The authentication unit 120 returns the processing to step S214 if not having received the coordinates related to the specification operation.

Moreover, in step S218, the change processing unit 104 supplies the identified coordinates to the display control unit 106. The display control unit 106 generates image information in which the coordinates are projected on the three-dimensional model to make the user confirm the point and/or region specified by the specification operation.

Subsequently, in step S220, the authentication unit 120 determines whether the point or the like for authentication has been input with respect to all places of the selected three-dimensional model. For example, if the point or the like for authentication has been registered at three places for the displayed three-dimensional model, the authentication unit 120 determines whether the coordinates at three places have been input for the selected three-dimensional model from the change processing unit 104.

The authentication unit 120 proceeds the processing to step S222 if determining that the point or the like for authentication has been input with respect to all places on the three-dimensional model or returns the processing to step S214 if not determining that the point or the like for authentication has been input with respect to all places on the three-dimensional model.

Subsequently, in step S222, the authentication unit 120 authenticates the user on the basis of the point or the like for authentication input from the user. First, the authentication unit 120 determines whether the three-dimensional model selected by the user out of the plurality of three-dimensional models is a three-dimensional model for authentication in step S210. Unless the selected three-dimensional model is intended for the authentication, the authentication unit 120 does not authenticate the user and proceeds the processing to step S224.

If the selected three-dimensional model is intended for the authentication, the detection unit 122 of the authentication unit 120 detects the similarity between the point or the like for authentication specified by the user and the preset point or the like for authentication.

For example, the detection unit 122 receives the coordinates of at least one of the point and region on the three-dimensional model from the registration unit 108. The detection unit 122 compares the point and/or region on the three-dimensional model related to the coordinates stored in step S218 with the point and/or region on the three-dimensional model related to the coordinates acquired from the registration unit 108 and then calculates the similarity in the point and/or region on the three-dimensional model between both.

As an example, if the comparison object is a three-dimensional model, the detection unit 122 may calculate the similarity by a distance between the coordinates of the points of both. If the comparison object is a region on a line of the three-dimensional model, the detection unit 122 may calculate the similarity by a distance between the start and end points of the lines of both, the length of the lines of both, a correlation between sets of coordinates of points obtained by sampling points constituting the lines of both at predetermined intervals, and/or a value of an inner product of vectors representing the lines of both.

Moreover, if the comparison object is a region on a surface of the three-dimensional model, the detection unit 122 may calculate the similarity by a sum or a product of the similarities between the lines constituting a surface of both. In addition, the detection unit 122 may calculate the similarity by a correlation between sets of coordinates of the points which change in curvature of lines constituting a surface of both, a correlation between sets of points obtained by sampling points constituting a surface at predetermined intervals, and/or a value of an inner product of vectors representing lines constituting a surface of both.

The authentication processing unit 124 of the authentication unit 120 makes the authentication successful on condition that the similarity is equal to or greater than a reference value. When there is a plurality of points and/or regions on the three-dimensional model for use in the authentication of the user, the authentication processing unit 124 may decide whether to make the authentication successful on the basis of a plurality of similarities detected with respect to a plurality of places on the three-dimensional model.

For example, the authentication processing unit 124 may make the authentication successful on condition that the similarities detected with respect to all of the plurality of places on the three-dimensional model are equal to or greater than a reference value. Alternatively, the authentication processing unit 124 may make the authentication successful on condition that the total of the similarities with respect to a plurality of places on the three-dimensional model is equal to or greater than a reference value.

The authentication processing unit 124 may make the authentication successful additionally on condition that the respective points and/or regions in the plurality of places on the three-dimensional model have been specified in the correct order. Specifically, the authentication processing unit 124 may reject the authentication of the user if the order of the specified points and/or regions is incorrect even if the user correctly inputs the points and/or regions themselves at the plurality of places.

Subsequently, in step S224, the authentication processing unit 124 determines whether the authentication is successful and proceeds the processing to step S230 if the authentication is successful. The authentication processing unit 124 terminates the processing if the authentication is unsuccessful.

Alternatively, even if the authentication is unsuccessful, the authentication processing unit 124 may return the processing to step S208 to make the user input the specification operation for authentication again. For example, if the similarity corresponding to the user's specification operation is less than the reference value, the authentication device 10 may allow an input of specification operations for a plurality of times by repeating the processing loop of steps S208 to S224.

In step S222, even if it is determined that the plurality of similarities corresponding to the specification operations for the plurality of times are less than the reference value, the authentication processing unit 124 may make the authentication successful on condition that the similarities are equal to or greater than the reference value if at least one of the plurality of points and the plurality of regions for authentication is selected out of at least one of the plurality of points and the plurality of regions specified by the respective specification operations for the plurality of times.

Thereby, even if the user cannot input the points or the like for authentication correctly in one-time operation on a small-screen touch panel or the like, the authentication processing unit 124 is able to authenticate the user if it is determined that the specification operations for the plurality of times match the registered points or the like for authentication as a whole.

In step S226, the display control unit 106 causes the display device 20 to display a screen for inputting a password. Thereby, the operation input unit 102 receives a password from the user if the user specifies the authentication with the password on the screen of step S204 on which the user's operation is input for the three-dimensional model. The operation input unit 102 supplies the password input from the user to the authentication unit 120.

Subsequently, in step S228, the authentication unit 120 reads the previously-stored password for authentication from the registration unit 108 and determines whether the input password input from the user in step S226 matches the password for authentication. The authentication unit 120 proceeds the processing to step S230 if both match each other or terminates the processing if not.

Subsequently, in step S230, the authentication unit 120 unlocks the authentication device 10. For example, the authentication unit 120 unlocks the operation lock screen of the authentication device 10. In addition, for example, the authentication unit 120 gives the user a permission to log in to the user account of the authentication device 10.

In this manner, the authentication system 1 according to this embodiment makes the user select one of the plurality of three-dimensional models through the processing of steps S202 to S230, thereby improving the authentication security.

Moreover, the authentication system 1 according to this embodiment inputs a change operation of moving and/or rotating a three-dimensional model selected by the user and a specification operation of specifying a point or the like on the three-dimensional model to be specified for authentication. Therefore, according to the authentication system 1, even if the user performs the same authentication operation repeatedly, objectively quite the same operation is unlikely to occur, thereby enabling the user to be authenticated more securely.

Moreover, according to the authentication system 1, the user is able to be authenticated not only with the specification operation on the three-dimensional model, but also with a password for authentication. For example, the authentication system 1 usually authenticates the user by making the user input the specification operation on the three-dimensional model. In a case, however, where the user forgets the specification operation after the user has not used the authentication device 10 for an extended period of time, the authentication device 10 is able to authenticate the user with a password for authentication written on a notebook or the like by the user, instead of inputting the specification operation. In this manner, the password for authentication is not usually used and therefore not repeatedly input in normal time, which reduces the risk that the third party will decode the password.

Additionally, if the user is authenticated with the password for authentication instead of the three-dimensional model, the change processing unit 104 of the authentication device 10 may receive the specification operation of the point and/or region for authentication from the user via the operation input unit 102 to register the coordinates of the point and/or region in the registration unit 108 anew. On this occasion, the password generation unit 110 may additionally generate a password for authentication corresponding to the point and/or region registered anew to update the existing password for authentication. Moreover, if the user has input an existing password for authentication, the registration unit 108 may reregister the password for authentication input anew from the user as a new password for authentication.

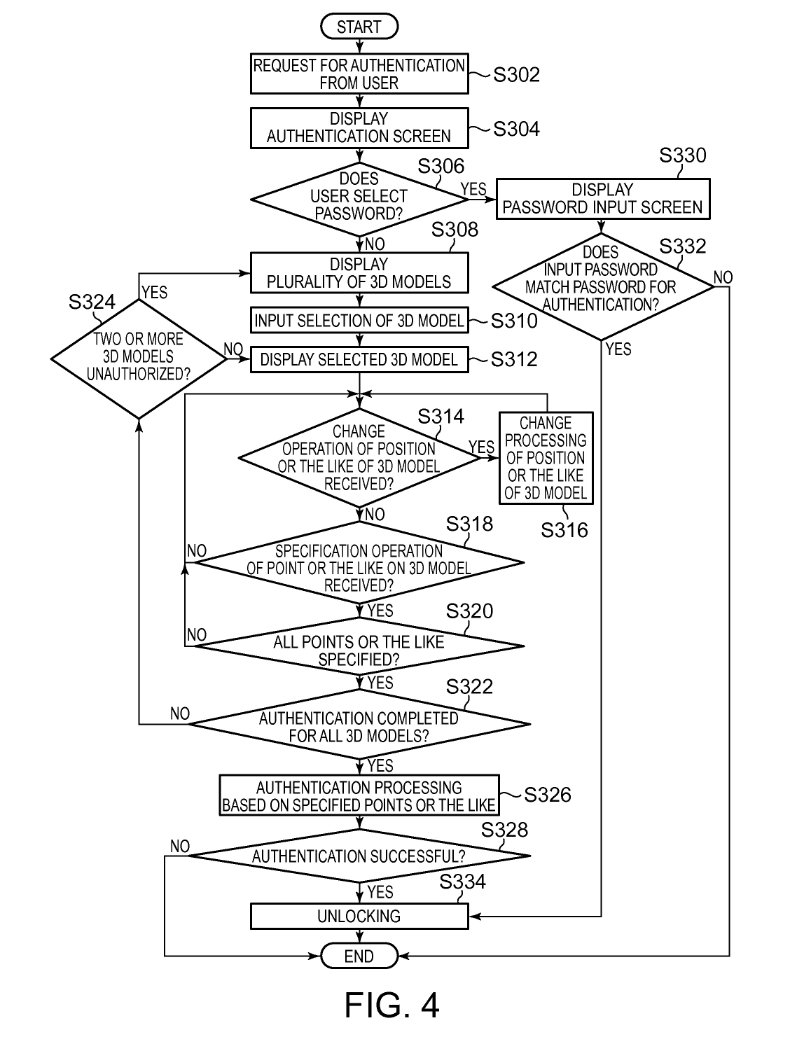

FIG. 4 illustrates a flow of the authentication processing of the authentication system 1 of a modification of this embodiment. In this embodiment, the authentication system 1 performs the processing of steps S302 to S334 to input the operation for a plurality of three-dimensional models, thereby authenticating the user.

Hereinafter, the same matters as those of the authentication processing flow of the modification illustrated in FIG. 3 will be omitted in some cases. In this modification, the matters of steps S302 to S306 may be the same as those described with respect to steps S202 to S206 of FIG. 2.

In step S308, the display control unit 106 causes the display device 20 to display three-dimensional models for which the user does not complete the input of the point or the like for authentication among a plurality of three-dimensional models used for authentication. The matters of step S310 may be the same as those described with respect to step S210 of FIG. 2.

Subsequently, in step S312, the change processing unit 104 causes the display device 20 to display the selected three-dimensional model. If there is only one three-dimensional model for which the user does not complete the input of the point or the like for authentication, there is no need to consider the user's selection and therefore the change processing unit 104 causes the display device 20 to display the three-dimensional model whose input is not completed.

In the modification, the matters of steps S314 to S320 may be the same as those described with respect to steps S202 to S206 of FIG. 2. If determining that the point or the like for authentication has been input with respect to all places on the three-dimensional model in step S320, the authentication unit 120 completes the input on the three-dimensional model and proceeds the processing to step S322.

In step S322, the authentication unit 120 determines whether the input of the point or the like for authentication is completed with respect to all three-dimensional models. For example, if the user is authenticated by using three three-dimensional models, the authentication unit 120 determines whether the coordinates of the point or the like with respect to all places have been input for the three three-dimensional models.

If determining that the input of the point or the like for authentication is completed for all three-dimensional models, the authentication unit 120 proceeds the processing to step S326. If not, the authentication unit 120 proceeds the processing to step S324.

In step S324, the authentication unit 120 determines whether there are two or more three-dimensional models for which the input of the point or the like for authentication is not completed. If there are two or more three-dimensional models for which the input is not completed, the authentication unit 120 returns the processing to step S308 to make the user select the three-dimensional model for which the input is required. If there is only one three-dimensional model for which the input is not completed, the authentication unit 120 proceeds the processing to step S312 to cause the display device 20 to display the three-dimensional model for which the input is not completed.

In step S326, the authentication unit 120 authenticates the user on the basis of the operations including the change operation of at least one of the position and posture input from the user with respect to each of the plurality of three-dimensional models. Specifically, the authentication unit 120 detects the similarity with the preset points or the like for authentication similarly to step S222 with respect to all points or the like for authentication input for the plurality of three-dimensional models and performs authentication processing on the basis of the detected similarity.

In this modification, the matters of the processing of steps S328 to S334 may be same as those described with respect to steps S224 to S230 of FIG. 2.

In this manner, the authentication system 1 of this modification makes the user input the point or the like for authentication for the plurality of three-dimensional models through processing of steps S302 to S334, thereby complicating the operation in authentication and thus improving the authentication security.

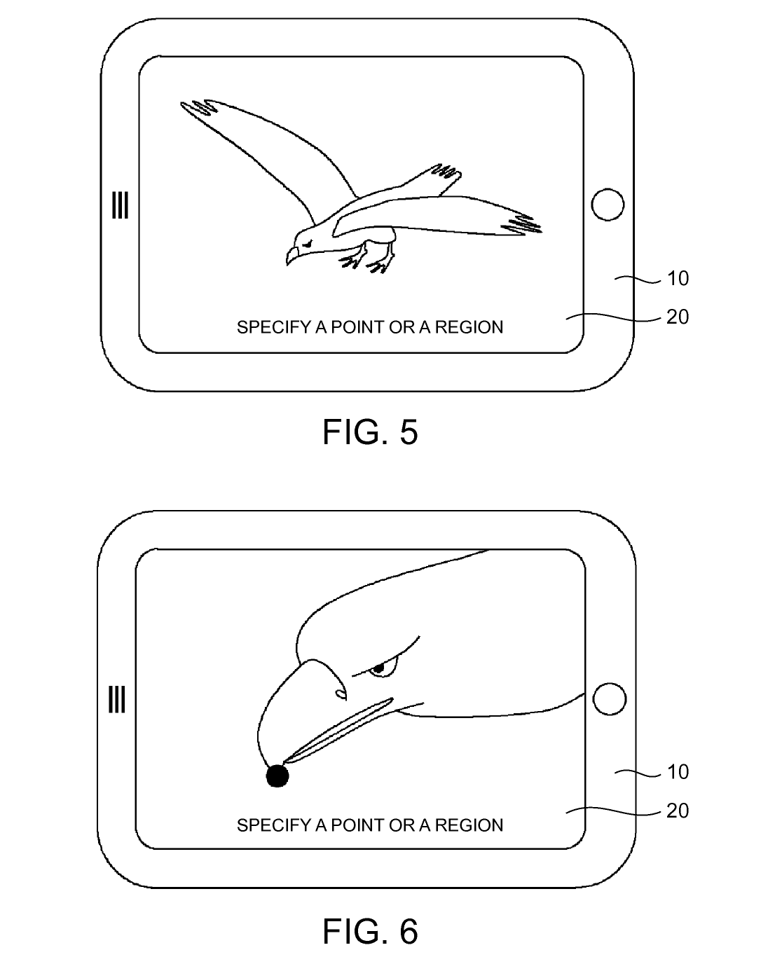

The following describes an example of a situation of an input of the specification operation on the three-dimensional model in the authentication registration and in the authentication processing with reference to FIG. 5 to FIG. 8. FIG. 5 illustrates an example of a three-dimensional model which the authentication device 10 causes the display device 20 to display in this embodiment.

As an example, the display control unit 106 displays a three-dimensional model as illustrated in FIG. 5 in step S104 of the authentication registration flow of FIG. 2, in step S212 of the authentication processing flow of FIG. 3, and in step S312 of the authentication processing flow of FIG. 4. The display control unit 106 may display a model of, for example, an animal or a plant, a building, or a vehicle as the three-dimensional model. In the example of FIG. 5, the display control unit 106 displays a bird.

FIG. 6 illustrates an enlarged view of a part (bird's head) of the three-dimensional model illustrated in FIG. 5. Upon receiving a change operation of bringing the three-dimensional model close to the viewpoint (for example, an operation of enlarging the region of the vicinity of the bird's head on the touch panel by sliding the region with two fingers) from the user via the operation input unit 102, the change processing unit 104 causes the display device 20 to display an enlarged image of a part of the bird illustrated in FIG. 6 via the display control unit 106.

In this regard, if the operation input unit 102 inputs an operation of tapping the touch panel at a point (for example, a bird's beak as illustrated) as specification operation, the change processing unit 104 identifies the tapped point (for example, the coordinates of the bird's beak) on the three-dimensional model as a point for authentication registration or a point for authentication in steps S112, S218, and S318.

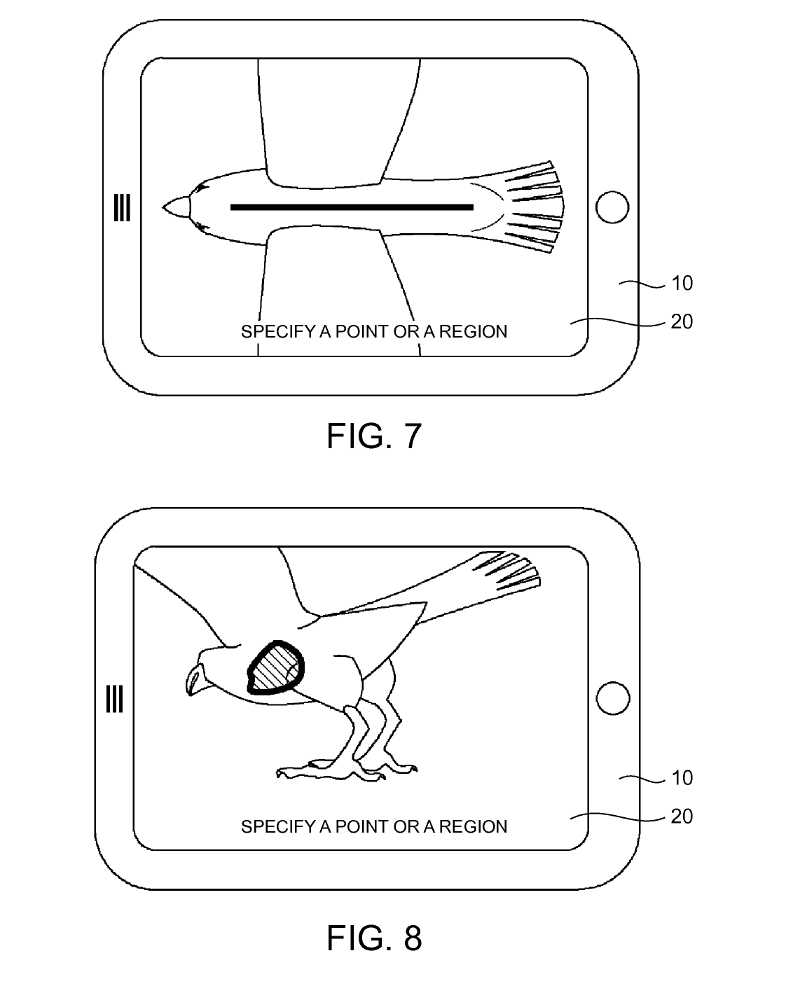

FIG. 7 illustrates an enlarged view of a part (a bird's back) of the three-dimensional model illustrated in FIG. 5. Upon receiving a change operation of changing the posture of the three-dimensional model (for example, an operation of sliding a finger on the bird on the touch panel in a rotational direction) and a change operation of enlarging the three-dimensional model from the user via the operation input unit 102, the change processing unit 104 causes the display device 20 to display an image in which the bird's back is enlarged as illustrated in FIG. 7 via the display control unit 106.

In this regard, if the operation input unit 102 inputs an operation of tracing a region on a line (for example, the center line on the bird's back as illustrated) on the touch panel as a specification operation, the change processing unit 104 identifies the region of the traced line of the three-dimensional model (for example, the coordinates of the points at both ends of the center line on the bird's back) as a region for authentication registration or a region for authentication in steps S112, S218, and S318.

FIG. 8 illustrates an enlarged view of a part (bird's rear side) of the three-dimensional model illustrated in FIG. 5. Upon receiving a change operation of changing the posture of the three-dimensional model (for example, an operation of sliding a finger on the bird on the touch panel in a rotational direction) and a change operation of enlarging the three-dimensional model from the user, the change processing unit 104 causes the display device 20 to display an image in which the bird's rear side is enlarged as illustrated in FIG. 8 via the display control unit 106.

In this regard, if the operation input unit 102 inputs an operation of tracing a region around a part (for example, the region under the bird's wing as illustrated) on the touch panel as a specification operation, the change processing unit 104 identifies the traced region of the three-dimensional model (for example, the coordinates of the respective vertices constituting the region under the bird's wing) as a region for authentication registration or a region for authentication in steps S112, S218, and S318.

As described above, in this embodiment, the authentication device 10 authenticates a user by a specification operation of specifying at least one of the point and region on the three-dimensional model input from the user while allowing the user to perform a change operation of at least one of the position and posture of the three-dimensional model. Alternatively, in a modification of this embodiment, the user may be authenticated by a change operation for the three-dimensional model.

In this case, in the authentication registration, the registration unit 108 may store the coordinates of the three-dimensional model and the coordinates of the viewpoint related to the change operation of the user, instead of the coordinates or the like of the three-dimensional model related to the specification operation. For example, the registration unit 108 stores the coordinates of the three-dimensional model before the change operation and the coordinates of the three-dimensional model after the change operation.

Then, in the authentication processing, the detection unit 122 detects the similarity between the coordinates of the three-dimensional model before and after the change operation input by the user and the coordinates of the three-dimensional model before and after the change operation stored in the registration unit 108. The authentication processing unit 124 may authenticate the user on the basis of the detected similarity related to the change operation.

In another modification of this embodiment, the operation input unit 102 has a direction sensor and an accelerometer and may input a user's change operation by the translation and/or rotation of the authentication device 10. Furthermore, the operation input unit 102 has a camera and may input a content obtained by analyzing a user's gesture taken by the camera as the user's change operation and specification operation.

Moreover, in this embodiment, the authentication device 10 makes a user freely input an arbitrary point and/or region on the three-dimensional model in the specification operation for specifying the point or the like for authentication. Alternatively, in a modification of this embodiment, the user may be made to specify the point or the like for authentication from the candidates for the point and/or region on the three-dimensional model previously determined.

In this case, when the user touches a portion of the three-dimensional model on the touch panel or the like, the display control unit 106 may provide an intensified display of the candidates for the point or the like on the three-dimensional model included in the touched portion. For example, when the user touches the bird's back as illustrated in FIG. 5 to FIG. 8, the authentication unit 120 may cause the display control unit 106 to brightly highlight the outlines of the bird's backbone, the bird's blade, and the like which are the candidates for the point or the like for authentication.

Moreover, in the modification, if the user is unsuccessfully authenticated, the display control unit 106 of the authentication device 10 may highlight points and/or regions or the like related to the unsuccessfully-input specification operation among the specification operations input by the user. Thereby, the authentication device 10 is able to give the user a clue about the specification operation.

This enables the user to know the candidates for the point or the like for authentication to be input as a specification operation in the displayed three-dimensional model and therefore the authentication device 10 is able to simplify the authentication.

In still another modification of this embodiment, the operation input unit 102 of the authentication device 10 may directly input numerical values of the coordinates of the point and/or region for authentication, instead of inputting the specification operation of the three-dimensional model. Thereby, the authentication device 10 is able to authenticate the user on the basis of the input numerical values of the coordinates even if the user cannot input the specification operation correctly.

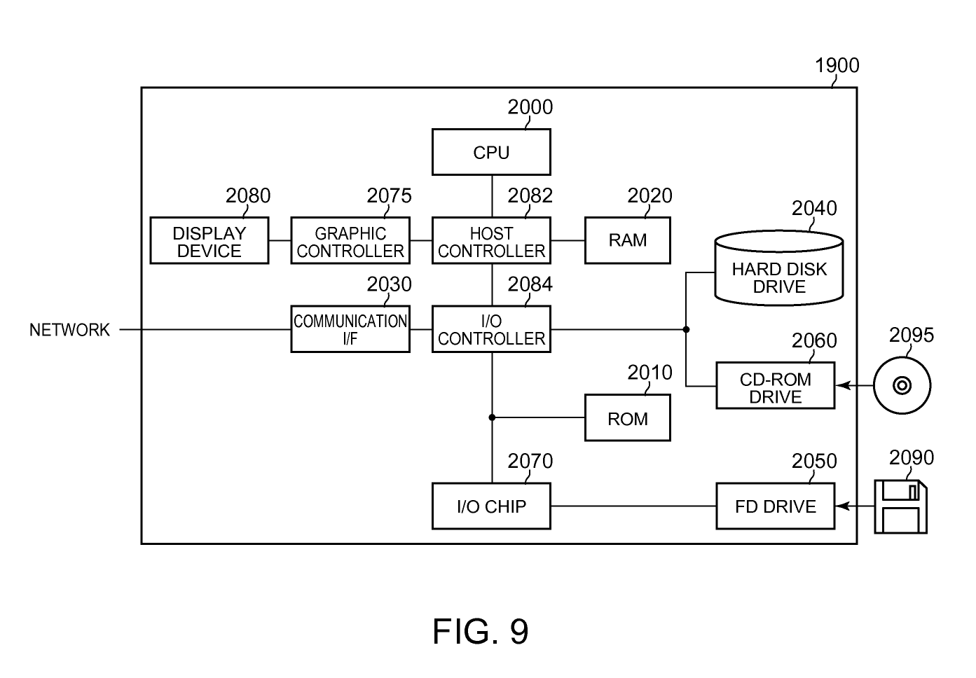

Referring to FIG. 9, there is illustrated an example of a hardware configuration of a computer 1900 which functions as the authentication device 10. The computer 1900 according to this embodiment includes a CPU peripheral unit, an input/output unit, and a legacy input/output unit. The CPU peripheral unit includes a CPU 2000, a RAM 2020, and a graphics controller 2075, all of which are mutually connected to one another via a host controller 2082. The input/output unit includes a communication interface 2030, a hard disk drive 2040, and a CD-ROM drive 2060, all of which are connected to the host controller 2082 via an input/output controller 2084. The legacy input/output unit includes a ROM 2010, a flexible disk drive 2050, and an input/output chip 2070, all of which are connected to the input/output controller 2084.

The host controller 2082 mutually connects the RAM 2020 to the CPU 2000 and the graphics controller 2075, both of which access the RAM 2020 at a high transfer rate. The CPU 2000 operates according to a program stored in the ROM 2010 and the RAM 2020 and controls each of the components. The graphics controller 2075 acquires image data generated by the CPU 2000 or the like in a frame buffer provided in the RAM 2020 and causes the display device 2080 to display the obtained image data. Alternatively the graphics controller 2075 may internally include a frame buffer in which the image data generated by the CPU 2000 or the like is stored. The display device 2080 may correspond to the display device 20 in this embodiment.

The input/output controller 2084 connects the host controller 2082 to the communication interface 2030, the hard disk drive 2040, and the CD-ROM drive 2060, all of which are relatively high-speed input/output devices. The communication interface 2030 communicates with another device via a wired or wireless network. In addition, the communication interface 2030 functions as hardware which communicates with outside. The hard disk drive 2040 stores, therein, a program and data to be used by the CPU 2000 in the computer 1900. The CD-ROM drive 2060 reads a program or data from a CD-ROM 2095 and provides the read program or data to the hard disk drive 2040 via the RAM 2020.

In addition, the input/output controller 2084 is connected to relatively low-speed input/output devices such as the ROM 2010, the flexible disk drive 2050, and the input/output chip 2070. The ROM 2010 stores a program such as a boot program executed at a start-up time of the computer 1900 and/or a program depending on hardware of the computer 1900 or the like. The flexible disk drive 2050 reads a program or data from a flexible disk 2090 and provides the read program or data to the hard disk drive 2040 via the RAM 2020. The input/output chip 2070 connects the flexible disk drive 2050 to the input/output controller 2084 and also connects various kinds of input/output devices to the input/output controller 2084 through a parallel port, a serial port, a keyboard port, a mouse port, and the like, for example.

A program to be provided to the hard disk drive 2040 via the RAM 2020 is provided by a user with the program stored in a recording medium such as the flexible disk 2090, the CD-ROM 2095, or an IC card. The program is read from the recording medium, then installed in the hard disk drive 2040 in the computer 1900 via the RAM 2020, and executed by the CPU 2000.

The program to be installed on the computer 1900 and to cause the computer 1900 to function as the authentication device 10 is provided with an operation input module, a change processing module, a display control module, a registration module, a password generation module, an authentication module, a detection module, and an authentication processing module. Such programs or modules may work on the CPU 2000 to cause the computer 1900 to function as the operation input unit 102, the change processing unit 104, the display control unit 106, the registration unit 108, the password generation unit 110, the authentication unit 120, the detection unit 122, and the authentication processing unit 124.

Information processing written in these programs is read by the computer 1900 and thereby functions as the operation input unit 102, the change processing unit 104, the display control unit 106, the registration unit 108, the password generation unit 110, the authentication unit 120, the detection unit 122, and the authentication processing unit 124, all of which are specific means resulting from cooperation of software and the aforementioned various types of hardware resources. The authentication device 10 specific to an intended purpose is built up by performing computation or processing for information in accordance with the intended purpose of the computer 1900 in this embodiment by use of such specific means.

In a case where communications between the computer 1900 and an external device or the like are performed, for example, the CPU 2000 executes a communication program loaded on the RAM 2020 and instructs the communication interface 2030 on the basis of processing contents described in the communication program to perform communication processing. Being controlled by the CPU 2000, the communication interface 2030 reads transmission data stored in a transmission buffer area or the like provided in a storage device such as the RAM 2020, the hard disk drive 2040, the flexible disk 2090, or the CD-ROM 2095 and then transmits the data to a network or writes reception data received from the network into a reception buffer area or the like provided on a storage device. As described above, the communication interface 2030 may transfer transmission and reception data between itself and a storage device by a direct memory access (DMA) scheme. Alternatively, the CPU 2000 may read data from a storage device or a communication interface 2030 of a transfer source and write the data into a communication interface 2030 or a storage device of a transfer destination to transfer the transmission and reception data. The storage device such as the RAM 2020, the hard disk drive 2040, the flexible disk 2090, or the CD-ROM 2095 may correspond to the registration unit 108 of this embodiment.

In addition, the CPU 2000 causes all of or a required portion of data to be read from a file or a database stored in an external storage device such as the hard disk drive 2040, the CD-ROM drive 2060 (CD-ROM 2095), the flexible disk drive 2050 (flexible disk 2090) into the RAM 2020 by DMA transfer or the like, and then performs various kinds of processing for the data in the RAM 2020. Then, the CPU 2000 writes the processed data back in the external storage device by DMA transfer or the like. In such processing, since the RAM 2020 can be considered as a device in which contents of an external storage device is stored temporarily, the RAM 2020 and an external storage device or the like are collectively termed as a memory, a storage unit, a storage device, or the like in this embodiment. Various types of information including various types of programs, data, tables, databases, and the like in this embodiment are stored in such a storage device and are handled as an information processing target. It should be noted that the CPU 2000 may retain a part of data in the RAM 2020 in a cache memory and then to read and write the data in the cache memory. In this case as well, since the cache memory partially shares the function of the RAM 2020, the cache memory is considered to be included in the RAM 2020, the memory, and/or the storage device except for a case where the cache memory is distinguished from the RAM 2020, the memory, and/or the storage device.

In addition, the CPU 2000 performs, on the data read from the RAM 2020, various types of processing being specified by a sequence of instructions of the program and including various types of computations, information processing, conditional judgment, information retrieval and replacement, and the like described in this embodiment, and writes the processed data back in the RAM 2020. In a case where the CPU 2000 performs conditional judgment, for example, the CPU 2000 determines by comparing a variable with the other variable or constant whether each of various types of variables described in this embodiment satisfies a condition whether the variable is larger, smaller, not less, not greater, equal or the like. If the condition is satisfied (or the condition is not satisfied), the processing of the CPU 2000 branches to a different instruction sequence or calls a subroutine.

In addition, the CPU 2000 is capable of searching for information stored in a file, a database, or the like in a storage device. For example, in a case where multiple entries having attribute values of a first attribute respectively associated with attribute values of a second attribute are stored in a storage device, the CPU 2000 searches the multiple entries stored in the storage device for an entry whose attribute value of the first attribute matches a specified condition. Then, the CPU 2000 reads an attribute value of the second attribute stored in the entry, and thereby, obtains the attribute value of the second attribute that satisfies a predetermined condition and that is associated with the first attribute.

The programs or modules described above may be stored in an external storage medium. As the recording medium, any one of the following media may be used: an optical recording medium such as a DVD or a CD; a magneto-optic recording medium such as an MO; a tape medium; and a semiconductor memory such as an IC card, in addition to the flexible disk 2090 and the CD-ROM 2095. Alternatively, the program may be provided to the computer 1900 via a network, by using, as a recording medium, a storage device such as a hard disk or a RAM provided in a server system connected to a private communication network or the Internet.

Thus, as described herein and according to a first aspect of the present invention, there is provided an authentication device which authenticates a user based on a user's operation, including: a display control unit which performs display control for displaying a three-dimensional model on a display device; an operation input unit which inputs a user's operation for the displayed three-dimensional model; and an authentication unit which authenticates the user based on an operation including a change operation of at least one of the position and posture of the three-dimensional model having been input from the user. According to other aspects of the invention, there are provided an authentication program therefor and an authentication method using the auxiliary device and the authentication.

According to an authentication method using a password, a user needs to remember the character string of a password correctly. Additionally, according to a conventional method, there is a problem such that it is difficult to authenticate the user unless the device is able to detect a user's viewpoint correctly. Thus, the present invention, as presented in various embodiments herein, provides an authentication device which authenticates a user based on a user's operation, including: a display control unit which performs display control for displaying a three-dimensional model on a display device; an operation input unit which inputs a user's operation for the displayed three-dimensional model; and an authentication unit which authenticates the user based on an operation including a change operation of at least one of the position and posture of the three-dimensional model having been input from the user.

The present invention has been described hereinabove with reference to illustrative embodiments. The technical scope of the present invention, however, is not limited to the above-described embodiments only. It is apparent to persons skilled in the art that various alterations and improvements may be made to the above-described embodiments. It is also apparent from the scope of the claims that the embodiments added with such alterations or improvements can be included in the technical scope of the invention.

It should be noted that the operations, procedures, steps, stages, and the like of each process performed by an apparatus, system, program, and method illustrated in the claims, embodiments, or diagrams can be performed in any order as long as the order is not particularly indicated by “prior to,” “before,” or the like and as long as the output from a previous process is not used in a later process. Even if the operation flow is described using phrases such as “first” or “next” in the claims, embodiments, or diagrams for convenience, it does not necessarily mean that the operation must be performed in this order.

What is claimed is:

1. An authentication device for authenticating a user based on a user's operation on a displayed three-dimensional model, the authentication device comprising:
a display control unit, wherein the display control unit is a processor-based logic that displays a three-dimensional model on a display device;
an operation input unit, wherein the operation input unit is a hardware unit that inputs a user's operation on the displayed three-dimensional model; and
an authentication unit, wherein the authentication unit is a processor-based logic that authenticates the user based on the user's operation, wherein the user's operation comprises a change operation of at least one of a position and posture of the three-dimensional model having been input by the user.

2. The authentication device according to claim 1, further comprising:
a change processing unit, wherein the change processing unit changes at least one of the position and posture of the three-dimensional model on a display screen in response to an input of a change operation of at least one of the position and posture of the three-dimensional model from the user.

3. The authentication device according to claim 2, wherein:
the operation input unit inputs a specification operation for specifying at least one of a point and a region on the three-dimensional model from the user; and
the authentication unit includes:
a detection unit, wherein the detection unit detects a similarity between at least one of the point and region on the three-dimensional model specified by the user and at least one of a preset point and region for authentication; and
an authentication processing unit, wherein the authentication processing unit confirms a successful authentication of the user in response to the similarity being equal to or greater than a reference value.

4. The authentication device according to claim 3, wherein the display control unit displays the three-dimensional model by using different initial values of at least one of the position and posture of the three-dimensional model before the input of the specification operation from the user in authentication processing which is performed at least more than once.

5. The authentication device according to claim 1, wherein:
the operation input unit inputs a specification operation of specifying at least one of the point and region on the three-dimensional model from the user with respect to a plurality of places on the three-dimensional model; and
the authentication processing unit determines whether an authentication of the user is successful based on the plurality of similarities detected with respect to the plurality of places on the three-dimensional model.

6. The authentication device according to claim 5, wherein the authentication processing unit makes the authentication of the user successful on further condition that at least the respective points or the regions in the plurality of places on the three-dimensional model have been specified in a correct order.

7. The authentication device according to claim 5, wherein the authentication processing unit makes the authentication of the user successful on further condition that the similarity detected with respect to all of the plurality of places on the three-dimensional model is equal to or greater than a reference value.

8. The authentication device according to claim 5, wherein the authentication processing unit makes the authentication of the user successful on further condition that a total of the similarities in the plurality of places on the three-dimensional model is equal to or greater than a reference value.

9. The authentication device according to claim 2, wherein:
the change processing unit changes at least one of the position and posture of the three-dimensional model on the display screen in response to the input of the change operation of at least one of the position and posture of the three-dimensional model from the user during a registration process of registering at least one of the point and region for authentication;
the operation input unit inputs a specification operation of specifying at least one of the point and region on the three-dimensional model from the user during the registration process; and
the authentication device further comprises a registration unit, wherein the registration unit registers at least one of the point and region on the three-dimensional model specified by the user during the registration process as at least one of the point and region for authentication.

10. The authentication device according to claim 9, wherein the change processing unit changes at least one of the position and posture of the three-dimensional model on the display screen in response to the input of the change operation of at least one of the position and posture of the three-dimensional model from the user after the registration process and makes the user confirm at least one of the point and region for authentication on the three-dimensional model.

11. The authentication device according to claim 9, wherein:
the operation input unit inputs the specification operation of specifying at least one of the point and region on the three-dimensional model from the user during the registration process for registering at least one of the point and region for authentication with respect to a plurality of places on the three-dimensional model; and
the registration unit warns the user of low authentication strength in a case where the specification of at least one of the point and region with respect to each of the plurality of places on the three-dimensional model specified by the user during the registration process is possible in the same position and posture of the three-dimensional model.

12. The authentication device according to claim 2, further comprising:
a password generation unit, wherein the password generation unit generates a password for authentication, wherein the password has been predetermined to be appropriate to an operation for authentication for the three-dimensional model, and wherein the password generation unit causes the display device to present the password for authentication to the user, wherein:
the operation input unit inputs the password from the user when the user specifies the authentication with the password on the display screen on which the user's operation is input for the three-dimensional model; and
the authentication unit authenticates the user in a case where the password input from the user matches the password for authentication.

13. The authentication device according to claim 1, wherein:
the display control unit displays a plurality of three-dimensional models on the display device; and
the authentication unit authenticates the user further on condition that a three-dimensional model selected by the user from the plurality of three-dimensional models is a three-dimensional model intended for authentication.

14. The authentication device according to claim 1, wherein:
the display control unit displays a plurality of three-dimensional models on the display device; and
the authentication unit authenticates the user based on an operation including the change operation of at least one of the position and posture, which has been input from the user with respect to each of the plurality of three-dimensional models.

15. The authentication device according to claim 1, wherein:
the operation input unit inputs specification operations for a plurality of times in a case where the similarity corresponding to the user's specification operation is less than a reference value; and
the authentication processing unit makes the authentication successful on condition that the similarity is equal to or greater than the reference value if at least the plurality of points or regions for authentication are selected out of at least the plurality of points or regions specified by the specification operations for the plurality of times, respectively, even if the plurality of similarities corresponding to the specification operations for the plurality of times are less than the reference value.

16. A method for authenticating a user based on a user's operation, the method comprising:
displaying a three-dimensional model on a display device;
receiving, by one or more processors, an input of a user's operation on the displayed three-dimensional model; and
authenticating, by one or more processors, the user based on an operation, wherein the operation comprises a change operation of at least one of the position and posture of the three-dimensional model having been input by the user.

17. The method of claim 16, further comprising:
changing, by one or more processors, at least one of the position and posture of the three-dimensional model on a display screen in response to an input of a change operation of at least one of the position and posture of the three-dimensional model from the user.

18. The method of claim 17, further comprising:
specifying, by one or more processors, at least one of a point and a region on the three-dimensional model from the user;
detecting, by one or more processors, a similarity between at least one of the point and region on the three-dimensional model specified by the user and at least one of a preset point and region for authentication; and
confirming, by one or more processors, a successful authentication of the user in response to the similarity being equal to or greater than a reference value.

19. A computer program product for authenticating a user based on a user's operation, the computer program product comprising a tangible computer readable storage medium having program code embodied therewith, the program code readable and executable by a processor to perform a method comprising:
displaying a three-dimensional model on a display device;
receiving an input of a user's operation on the displayed three-dimensional model; and
authenticating the user based on an operation, wherein the operation comprises a change operation of at least one of the position and posture of the three-dimensional model having been input by the user.

20. The computer program product of claim 19, wherein the method further comprises:
changing at least one of the position and posture of the three-dimensional model on a display screen in response to an input of a change operation of at least one of the position and posture of the three-dimensional model from the user;
specifying at least one of a point and a region on the three-dimensional model from the user;
detecting a similarity between at least one of the point and region on the three-dimensional model specified by the user and at least one of a preset point and region for authentication; and
confirming a successful authentication of the user in response to the similarity being equal to or greater than a reference value.
